(19) United States
(12) Patent Application Publication
(10) Pub. No.: US 2008/0319890 A1
(43) Pub. Date: Dec. 25, 2008

(54) System and Method of Enabling an Interactive Online Sales Process for Electronic Real Estate Transactions

(75) Inventors: Artur Marek Urbanski, Burlingame, CA (US); Santosh Varghese Philip, Berkeley, CA (US)

Correspondence Address: FLIESLER MEYER LLP, 650 CALIFORNIA STREET, 14TH FLOOR, SAN FRANCISCO, CA, 94108, US

(73) Assignee: CIMPLER REAL ESTATE, INC., Burlingame, CA (US)

(21) Appl. No.: 11/768,155

(22) Filed: Jun. 25, 2007

(51) Int. Cl. G06Q 40/00; G06F 17/30; G06F 17/40

(52) U.S. Cl. 705/37

(57) ABSTRACT

An interactive online sales process is presented for electronic real estate transactions. The process includes initializing a bidding file and instantiating an electronic sale transaction based on the data in the file. Parameters of the sale can be customized by a seller or listing agent. An electronic bid can be generated and populated with input received from a buyer. The electronic bid can include standard and custom conditions. A time limit can be set to acknowledge the electronic bid. The time limit is gradually reduced, and upon expiration of the time limit, the process is suspended if the electronic bid has not been acknowledged. Once the seller acknowledges the bid, the interactive sale transaction can be resumed. An electronic bid can be tagged as being a favorite or as being the accepted bid. Upon acceptance, the transaction can complete by populating a contract form with data retrieved from the transaction.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The current invention relates generally to electronic real estate transactions and more particularly to providing an interactive online sales process for electronic transactions.

### BACKGROUND

In recent years, electronic online sales and auction sites have become more and more widely used in a variety of different contexts. Many such sites have been set up in order to allow people and businesses to buy and sell goods and services worldwide over the internet. These sites typically allow their users to play the part of a buyer and a seller, where the seller lists an item offered for sale and the buyers submit competing bids, hoping to win the contract.

In a common auction-style listing, a current bid is typically displayed as the minimum bid, until a second (higher) bid is made, at which point the second bid is displayed as the current bid, and so on. Once the process completes, the highest bid is normally awarded the item in exchange for tender of the offered purchase price. In this manner, the seller is theoretically provided with the ability to obtain the highest market price for his or her product(s).

While online auction systems, such as described above, have proven useful for a multitude of goods and services, there exist certain classes of items which do not conform well to the standard online auction process. For example, real estate transactions have not had as much success with integrating into online auction systems because they pose a number of issues and difficulties which are not found with typical products. As an illustration, in typical auction systems, the highest bid in terms of price usually has priority and simply wins the contract over all lower bids. In real estate negotiations, however, the price of the offer may not be the only, nor the most important factor in awarding the contract and concluding the sale under certain circumstances. A multitude of other factors may play significant roles, such as repairs to property, costly improvements, various uses, licenses, and the like. Furthermore, real estate negotiations often involve multiple conditions on the sale, bidirectional communications between the buyer and seller and a number of other concerns. The lack of process intelligence able to account for such factors has caused significant inconveniences and barriers for electronic real estate transactions.

In light of the above, it would be desirable for a system that accounts for all or most variables of real estate negotiation, informs and facilitates communications between the buyers and sellers, and ensures that each sales listing is up to date with the current state of the property. Applicants have identified the foregoing as well as other needs, which currently exist in the art, in coming to conceive the subject matter of the present disclosure.

### BRIEF DESCRIPTION OF THE DRAWINGS

FIG. 1 is an illustration of a system-level example, in accordance with various embodiments.

FIG. 2 is an exemplary flow chart diagram of a general process in accordance with various embodiments.

FIG. 3 is an exemplary flow chart diagram of an interactive sale transaction process, in accordance with various embodiments.

FIG. 4 is an illustration of several examples of conditions associated with the interactive sale transaction, in accordance with various embodiments.

FIG. 5 is an illustration of data comparison for several electronic bids of the interactive sale transaction, in accordance with various embodiments.

### DETAILED DESCRIPTION

The invention is illustrated by way of example and not by way of limitation in the figures of the accompanying drawings in which like references indicate similar elements. References to embodiments in this disclosure are not necessarily to the same embodiment, and such references mean at least one. While specific implementations are discussed, it is understood that this is done for illustrative purposes only. A person skilled in the relevant art will recognize that other components and configurations may be used without departing from the scope and spirit of the invention.

In the following description, numerous specific details will be set forth to provide a thorough description of the invention. However, it will be apparent to those skilled in the art that the invention may be practiced without these specific details. In other instances, well-known features have not been described in detail so as not to obscure the invention.

Although a diagram may depict components as logically separate, such depiction is merely for illustrative purposes. It can be apparent to those skilled in the art that the components portrayed can be combined or divided into separate software, firmware and/or hardware components. For example, one or more of the embodiments described herein can be implemented in a network accessible device or appliance. Furthermore, it can also be apparent to those skilled in the art that such components, regardless of how they are combined or divided, can execute on the same computing device or can be distributed among different computing devices connected by one or more networks or other suitable communication means.

In accordance with various embodiments, there are provided systems and methods for enabling an interactive online sales process for electronic real estate transactions. The sales process can be implemented as an interactive web site application deployed on a server that manages a multitude of clients connected to a network, such as the internet. By way of non-limiting example, the server can be a web server or an application server. The server can accept hypertext transfer protocol (HTTP) requests from various clients and can provide web pages that contain hypertext markup language (HTML) information.

In one embodiment, the sales process can begin by a user (e.g. real estate listing agent) setting up a bidding file, from which the interactive sales process will be instantiated. The bidding file can be set up by using a multiple listing service (MLS) “Listing Producer” and a transaction processing system, and can contain MLS data and other information about a particular real estate listing. For example, the information may include the property listing information, agent/broker information and disclosures regarding the real estate listing.

In one embodiment, the listing agent user can also customize the parameters of the interactive sale transaction by specifying the sale length, a start time, a time limit to acknowledge each electronic bid, a starting bidding price, a minimum reserve price and the default values of the standard conditions for the sale. In other embodiments, some of these parameters may not be specified by the listing agent and can instead be pre-set values, or can be specified by other users of the system, such as the seller.

Once the parameters are specified, the bidding logic component can be activated and the bidding can begin for the transaction. The bidding can take the form of electronic communications and data exchanged between the various clients and the bidding logic component of the system. This particular point in time indicates the sale start time, which can be specified as a custom parameter by a listing agent or seller.

In various embodiments, an electronic bid is generated for a buyer and submitted to the bidding logic module. In one embodiment, the electronic bid is a two-way communication mechanism between a buyer and a seller that can be implemented as a database table, an instantiated class, an object, a bean, or the like. In various embodiments, the information associated with the electronic bid can be stored and accessed through a number of means, including but not limited to relational databases, digital files, read-only memory, random access memory (RAM), lookup tables and various caches. The fields of the electronic bid can be populated by the buyer, such as the bid amount, any standard or modified conditions or other parameters. In one embodiment, the buyer can bid an amount with standard conditions, customize a default value or create a set of custom bid conditions by modifying a default value. As an illustration, the buyer can add a custom condition beyond one that is presently defined for the sale, such as “I would like seller to paint the kitchen and this to become a formal sale condition.” In this case, if the seller agrees, the condition can be added to the set of custom conditions during bid acknowledgement, as will be described below.

In various embodiments, there are two types of conditions associated with the electronic bid—the standard conditions and the custom conditions. Furthermore, each standard condition can be either fixed or customizable (i.e. can be modified during bidding process). In the event that the standard condition is customized during the bidding, that standard condition will become part of the set of custom conditions. In one embodiment, up to a specified number of custom conditions are left blank at the beginning of each electronic bid. These conditions and their values can be proposed, defined and accepted as part of a custom bid during the bidding process.

Once the electronic bid has been generated, it can be submitted (e.g. by or on behalf of a client) to the bidding logic component of the system. After receiving the electronic bid, the bidding logic can initiate a time limit count to acknowledge the bid by the seller. In other words, once the bid is received, the bid clock begins measuring the time in which the seller has to either acknowledge having received the bid and/or provide comments/response. If no acknowledgement is received by the specified electronic deadline, the bidding process is suspended.

This feature of the system can force the seller to respond to each electronic bid by acknowledging the bid or by posting a reply. Once the seller acknowledges the electronic bid, it can be tagged as having been reviewed/acknowledged and displayed on the interactive listing as one of the previously posted bids. In one embodiment, if the seller fails to acknowledge the electronic bid within the time limit allowed, all future bidding is frozen for this particular interactive sale transaction. As such, no other electronic bids will be accepted for the real estate listing after the deadline, until the seller acknowledges the expired electronic bid. In some embodiments, the seller can effectively unfreeze (resume) the process by acknowledging the expired bid, at which point new bids can once again be submitted for the listing.

The feature of forcing acknowledgments from the seller can allow for significant advantages to the process, such as making certain that all listings are current and up to date. The buyer is informed that the seller has reviewed each electronic bid and considered the respective offer, while the seller is provided with the opportunity to respond to each bid by posting various comments, providing new conditions or accepting the sales offer. This feature of the bidding logic component allows the process to more closely resemble real-world real estate transactions between buyers and sellers and provides more flexibility and customization to the interactive sales process.

In various embodiments, the electronic bids can also be tagged or designated by the seller as the current favorite bid. As an example, the seller can select one pending bid and tag it as a current favorite in order to inform all other buyers of the specific price and conditions that he may deem favorable. The price need not be the determining factor in the designation, since the decisions to accept/deny real estate offers are often decided on a variety of different parameters, above and beyond the actual price. As an illustration, the custom conditions placed on the bid may significantly affect the offer, such as in the case where the buyer conditions the bid on the seller performing costly repairs or improvements to the property.

In one embodiment, the bidding can end by the seller accepting the offer, which also need not be the highest bid in terms of price, as previously discussed. Alternatively, the bidding can terminate at the expiration of the sale length period, which can be specified as a parameter during the set up of the transaction.

In various embodiments, following acceptance of an electronic bid, the seller and buyer can enter an escrow process. In one embodiment, a standard set of contracts can be automatically generated by retrieving the data from the electronic bid and populating the set of contracts with that data. Because the electronic bidding logic software reflects the logic of standard real-world contracts and negotiations, the data retrieved from the transaction can be easily and automatically incorporated into the standard contracts. Alternatively, the standard contracts can be created manually. It should be noted that the real estate standard contracts can vary significantly across different locations and the present invention is not limited to any single specific contract form. By way of illustration, a listing in northern California may include a California Association of Realtors (CAR) contract, a PRDS contract available from the Silicon Valley Association of Realtors or San Francisco Real Estate Associate contract. These or other standard contracts can be generated by a component of the system described herein, based on the data retrieved from the bidding logic module.

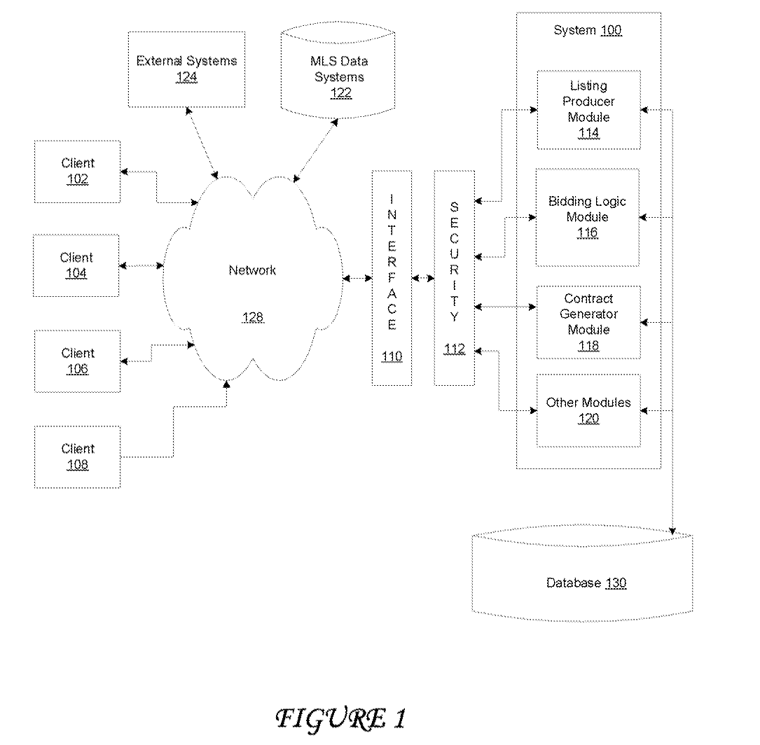

FIG. 1 is an illustration of a system-level example, in accordance with various embodiments. Although this diagram depicts components as logically separate, such depiction is merely for illustrative purposes. It will be apparent to those skilled in the art that the components portrayed in this figure can be arbitrarily combined or divided into separate software, firmware and/or hardware. Such components, regardless of how they are combined or divided, can execute on the same computing device or can be distributed among different computing devices connected by one or more networks or other suitable communication means. Furthermore, it will also be apparent to one of ordinary skill in the art that certain components can be added, interchanged or removed from this figure without departing from the scope of the various embodiments.

As illustrated, the interactive sales process can be deployed and executed on a system 100 connected to a wide area network 128, such as the internet. The system can include a listing producer module 114, a bidding logic module 116, and a contract form generator module 118. Various other modules 120, such as an administrator module can also be included in the system, within the scope of the present disclosure. Furthermore, the illustrated modules can be integrated with one another in various ways, so long as certain functionality is preserved. In various embodiments, the system can also include an interface layer 110, such as a graphical user interface (GUI), and a security layer 112 that provides authentication and authorization services for various users of the system.

In one embodiment, a listing producer module 114 is a software application that can generate a website or a portion thereof by importing multiple listing service (MLS) data for a particular real estate listing from MLS data systems 122. As used in this specification, an MLS system is an electronic database for real estate that enables access to data among brokers that represent buyers and sellers in order to facilitate the sharing of information about various properties. The listing producer module 114 can provide a set of templates for generating a real estate listing and associated MLS data in a particular format or layout and publishing the listing on the system 100. In one instance, it can automatically (or manually) extract the parameters of the listing from the local real estate association MLS listing system and sets up a bidding file for the interactive process. In one embodiment, the listing producer application is available from Baynet World, Inc., of Cupertino, Calif.

The bidding logic module 116 is a software component of the system that is responsible for carrying out the execution of the interactive bidding process. In various embodiments, the bidding logic module allows users qualified by a listing agent to submit electronic bids, initiates timing deadlines for acknowledging the bids, suspends, resumes, and terminates the bidding process and performs various other steps of the process described herein. It should be noted that the bidding logic module can also be subdivided into a plurality of software modules or distributed among multiple computer systems connected via the network. The data associated with each bidding process instance can be persisted in a data store 130 accessible by the various modules of the system, such as a relational database, repository or data management system.

The contract generator module 118 can be a software component that completes a specified contract form with the information from particular transaction. In one embodiment, contract generator is activated upon acceptance of an electronic bid and at this point retrieves data associated with the interactive sales instance and populates a selected contract form with that data. The contracts can then be used to enter a standard escrow process and otherwise finalize the property sale.

A number of users on various clients 102, 104, 106, 108 can be connected to the internet and obtain access and services from the system 100. There can be a variety of types of users within the context of the sales process. As an example, users on clients 102 and 104 may be pre-qualified buyers, while a user on client 106 may be a seller, and client 108 may have guest or “view-only” type of access. In one embodiment, a user is assigned to guest status until he or she is pre-qualified by a listing agent. Upon being pre-approved, the user can be provided with identification and password, or other means of authentication to obtain access to the system as a buyer. Buyers can then submit bids on a particular listing. Other users of the system can also include listing agents, administrators, commercial third party users of various external systems 124 and the like.

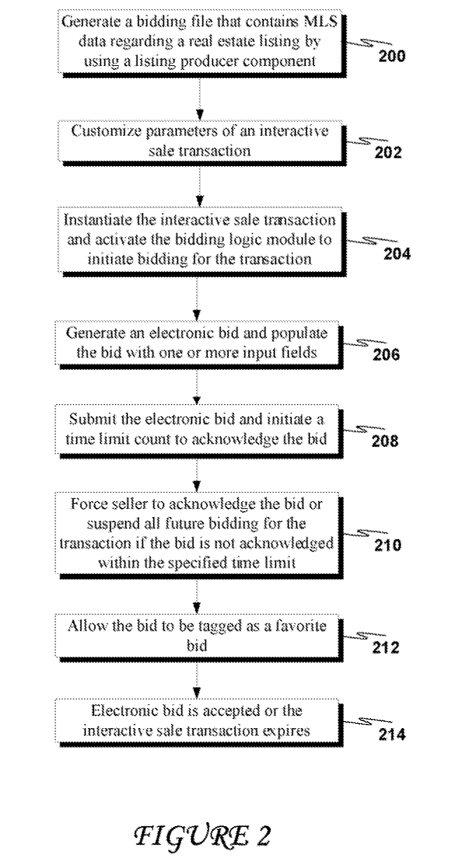

FIG. 2 is an exemplary flow chart diagram of a general process in accordance with various embodiments. Although this figure depicts functional steps in a particular sequence for purposes of illustration, the process is not necessarily limited to this particular order or steps. One skilled in the art will appreciate that the various steps portrayed in this figure can be changed, rearranged, performed in parallel or adapted in various ways. Furthermore, it is to be understood that certain steps or sequences of steps can be added to or omitted from this process, without departing from the spirit and scope of the invention.

As shown in step 200, a bidding file can first be generated for the interactive sale transaction. In one embodiment, the bidding file is set up by a real estate listing agent by using an MLS listing producer and a transaction processing system. The bidding file can be any type of file stored in memory, such as an extensible markup language (XML) file, that contains information regarding a real estate listing. In one embodiment, the listing agent can provide the necessary information such as the copy of the listing agreement and addendum, transfer disclosure statement (TDS), a home inspection report (HIR), natural hazard disclosure (NHD), a link to the client version of the MLS listing, house pictures in digital format, a link to a virtual tour if available, a comparative market analysis (CMA), disclosures and reports specific to a particular location, and any other data relevant to a real estate listing. In alternative embodiments, the seller can also be allowed to set up the bidding file.

In step 202, the parameters of the interactive sale transaction instance are customized. Once again, this can be performed by a listing agent or by a seller of the property. In one embodiment, the listing agent specifies the overall length of the sale process, the start time, the seller acknowledgement/reply time, the starting bidding price, the minimum reserve price and a set of default values of all standard conditions. In various alternative embodiments, some of these parameters can be optional, omitted and various other parameters can be added to the process. Once, the bidding file is generated and the parameters of the sale are customized, the listing can be published.

In step 204, the interactive transaction is instantiated and the bidding logic module is activated to initiate the bidding process on the published listing. At this point, the various clients having a connection to the system can submit electronic bids to the bidding logic component. As illustrated, in step 206, an electronic bid is generated and its fields are populated with one or more values. As an example, the elements of the bid can include the bid amount, standard or modified conditions, any new custom conditions created by the buyer, an electronic deadline, a favorite field, a status (accepted/not) field, an acknowledged status, and any other data fields for specifying information relating to an electronic bid.

In step 208, the electronic bid is submitted to the bidding logic module and at this point a time limit count can be initiated for counting down the time to deadline for acknowledging the bid. In one embodiment, the deadline can be expressed by the following equation: deadline=bid_time_stamp+time_to_deadline, where the bid_time_stamp represents the system clock time at which the bid was created and the time_to_deadline is a variable initialized when the interactive sale transaction is first set up. In alternative embodiments, a variety of other equations can also be used so as to gradually reduce the time period allowed for acknowledging the bid.

In step 210, the seller is required to acknowledge the electronic bid within the specified time period. If the seller acknowledges the bid within the time allowed, the bid is tagged as having been acknowledged and it is listed as part of the set of previous acknowledged bids. If, on the other hand, the seller fails to acknowledge or respond to the bid, the bidding process is suspended indefinitely or at least temporarily. In one embodiment, the listing agent (or seller) can un-freeze the process by acknowledging or replying to the bid.

In step 212, the electronic bid can be tagged as a seller's favorite bid. In one embodiment, only one of the pending bids can be tagged as a favorite so as to indicate a seller's preferred price, conditions and the like. In various embodiments, all electronic bids can be either acknowledged or newly pending. One of the acknowledged bids can be tagged as a seller's favorite and one can be accepted by the seller.

In step 214, the interactive sales process can terminate with either acceptance of the bid or at the expiration of the total sale length period. If the bid is accepted by a buyer, a contract form can be populated with the various data associated with the transaction instance. For example, the final sales price can be entered into the contract, as well as all pending conditions (standard and custom) of the accepted bid. Various other information associated with the real estate listing can also be entered into the contract.

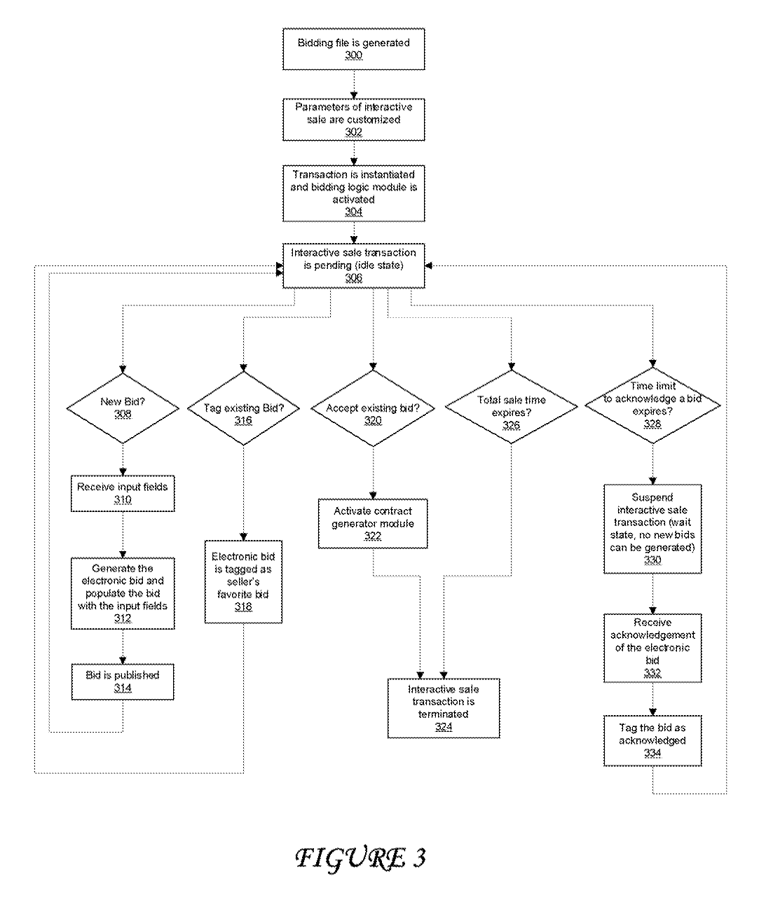

FIG. 3 is an exemplary flow chart diagram of an interactive sale transaction process, in accordance with various embodiments. Although this figure depicts functional steps in a particular sequence for purposes of illustration, the process is not necessarily limited to this particular order or steps. One skilled in the art will appreciate that the various steps portrayed in this figure can be changed, rearranged, performed in parallel or adapted in various ways. Furthermore, it is to be understood that certain steps or sequences of steps can be added to or omitted from this process, without departing from the spirit and scope of the invention.

As illustrated in step 300, a bidding file can be created, which contains data associated with a selected real estate listing. The creation of the bidding file has been discussed previously, however in essence it involves obtaining the data for the listing by querying an appropriate electronic database system. Once the bidding file is created, the parameters of the sale can be customized, as shown in step 302. The parameters can be specified by a seller or by a listing agent and it can include specifying the sale length, bid acknowledgement length, the various conditions for the sale and the like.

In step 304, once all of the parameters have been initialized, the listing is published and the bidding logic can be activated. In one embodiment, the interactive sale transaction can be in an idle state until a specified event occurs, as shown in step 306.

One such event can be the submission of a new electronic bid for the transaction instance (step 308). An electronic bid can be generated by a remote client or by the system and can contain a set of parameters specified by the buyer. In various embodiments, each new bid can be made with either the standard conditions (posted by the listing agent prior to sale) or custom conditions (if a bidder modifies the default values). Thus, in step 310 input is received from the buyer and the bid is populated with the buyer-selected values in step 312. In one embodiment, the input of the buyer includes (1) a bid amount (price); (2) specification of bid conditions (standard or custom); and (3) any comments desired to be posted. Once the electronic bid is generated, it can be published to the interactive site for view by other users (step 314). In alternative embodiments, the bid may not be posted until actually acknowledged by the seller.

Once the electronic bid is submitted, a timer is initiated for acknowledging the bid by the seller. In one embodiment, the seller must acknowledge every electronic bid or the bidding process will be frozen by the system. As shown in steps 328 and 330, if such a timer to acknowledge a bid expires, all bidding associated with the instance of the interactive sale transaction is suspended. As such, the transaction remains in an idle state, accepting no further bids until an acknowledgment is received for this particular bid. Once the seller does acknowledge the expired bid (step 332), the bid can be marked appropriately (step 334) and the bidding process can be resumed.

Another event that can occur, is the system receiving input from the buyer that tags an existing bid as the current favorite, as illustrated in step 316. In one embodiment, this causes the system to electronically tag the selected bid as a favorite (step 318), which can be performed by setting a flag or filling in a parameter on the bid object. Subsequently the bid will be displayed to all users as a favorite bid, indicating the seller's preferred conditions, price etc.

Another event that can occur, is the system receiving input from the seller, indicating acceptance of the bid (step 320). In various embodiments, only one bid can be accepted and once having done so, the interactive sale process is deemed to have been completed. In one embodiment, a contract can be generated upon acceptance of the bid, as shown in step 322. This can be performed by a contract generator component of the system, which automatically retrieves data associated with the transaction instance and the winning bid and inserts the data into a standard real-estate form contract. Once this is executed, the interactive sale transaction instance is considered complete (step 324) and the buyer and seller can enter the standard escrow process.

Alternatively, the interactive sale can be terminated by expiration of the total sale length parameter, as illustrated in step 326. This custom parameter can be specified at the initialization of the process to be any particular number of hours, days, or months. If no electronic bid has been accepted by the expiration of the sale length, the interactive sale transaction is terminated in step 324.

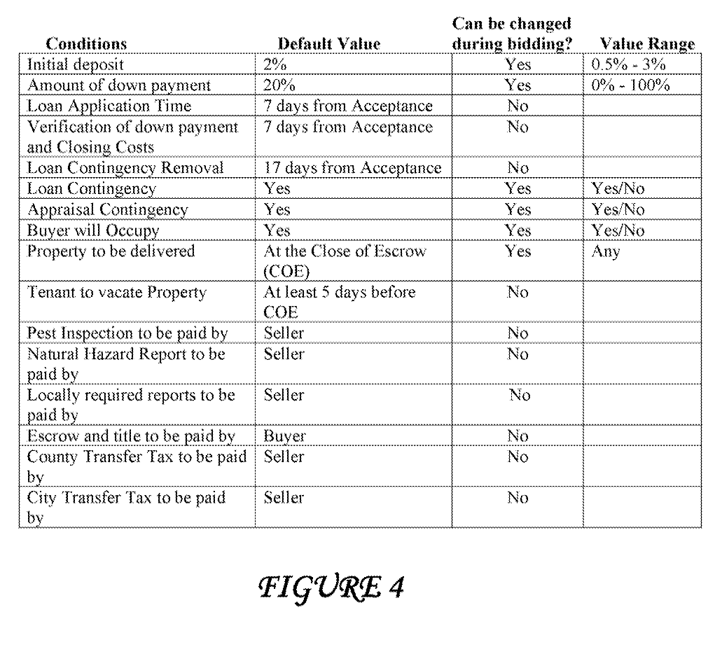

FIG. 4 is an illustration of several examples of conditions associated with the interactive sale transaction, in accordance with various embodiments. It should be understood that the conditions illustrated herein are not intended to be exhaustive in any way and that a large number of variations is possible, in addition to the shown conditions.

The table in FIG. 4 illustrates a list of exemplary possible conditions associated with an interactive real estate transaction. As shown, the conditions can include a default value, which may or may not be customizable during the bidding process. In one embodiment, a default value is initialized during the set up of the interactive sale transaction, such as when customizing the parameters of the sale, as previously described. Subsequently, the default value may or may not be customizable by the buyer during the bidding process. As an example, the initial deposit to secure the particular listing associated with the transaction is set to a default value of 2% of the purchase price, and is further modifiable by a buyer or listing agent so long as the value stays between 0.5% and 3%. On the other hand, a different condition can require that the seller pay for the natural hazard report (NHR) and this condition is not allowed to be modified. Various other conditions are also possible, as shown in FIG. 4.

In various embodiments, two types of bid conditions are possible—the standard condition and the custom condition. Furthermore, the standard conditions can be further broken down into those conditions that are customizable and those that are fixed. If a standard customizable condition is customized during the bidding process, it becomes part of the set of custom conditions associated with the electronic bid. Additionally, the buyer can define new custom conditions and add them to the electronic bid. In one embodiment, a specific number of custom conditions are left blank at the beginning of each bid. These conditions and their values can be proposed, defined and accepted as part of the custom bid during the bidding process. In various embodiments, all conditions can be viewed by the public (guests, buyers, etc.) on the interactive site.

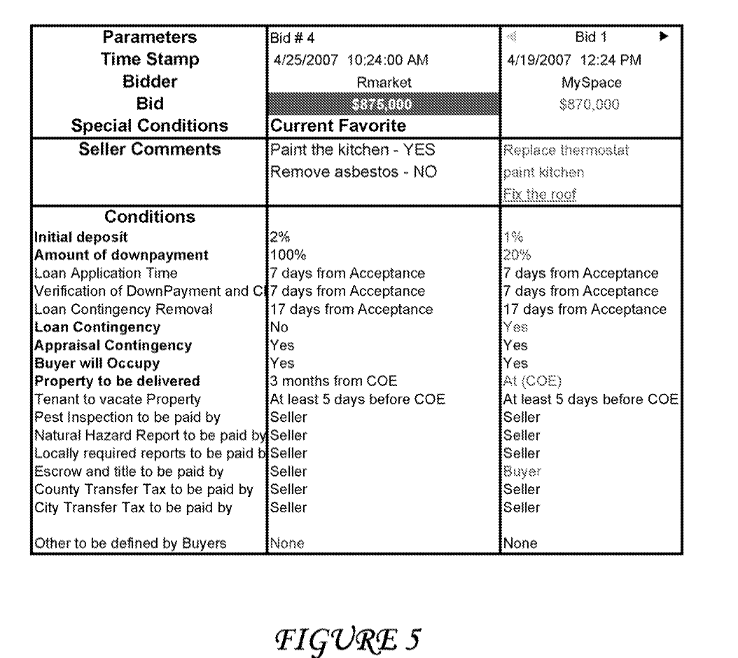

FIG. 5 is an illustration of data comparison for several electronic bids of the interactive sale transaction, in accordance with various embodiments. It is to be understood by one of ordinary skill in the art that the particular data and its arrangement shown here is presented purely for illustrational purposes and that many other variations of such data and its display arrangements are possible.

As illustrated, data associated with several electronic bids can be compared and contrasted by way of display on the interactive sale system. In this embodiment, electronic bid 4 is tagged as the seller's current favorite bid, indicating the seller's preferable conditions, price and response comments. In various embodiments, the seller can add such response comments during acknowledgement of the bid, as previously discussed.

Each electronic bid can be automatically analyzed and compared with other bids by displaying its associated data in a row and column format. In certain embodiments, the differences between the preferred bid and any other bid can be highlighted so as to accentuate the seller's preferable conditions and other variables. As illustrated in the figure, in addition to price, bid 4 can have the differentiating conditions of initial deposit, amount of down payment and the property delivery date. In alternative scenarios, other conditions can be emphasized so as to indicate the seller's preferences to all potential buyers. In one embodiment, seller and buyer can compare previous bids by scrolling, such that the preferred bid is compared to one other bid at a time. In alternative embodiments, more than two bids can also be displayed and analyzed simultaneously at any given time.

As previously discussed throughout this specification, a number of different users can be allowed to access the services of the system described herein. For example, a seller can be a person selling a real estate property. A buyer can be a person participating in bidding for a property directly or indirectly (via a selling agent). In one embodiment, a buyer must be pre-approved. A listing agent of the seller can be a user responsible for setting up the interactive process, customizing the rules of the process and performing bidding on behalf of the seller. A guest user can be a person viewing the bidding process. In various embodiments, once the guest user is pre-approved he or she becomes a potential buyer. A number of other users can also access the system described herein, including but not limited to administrators, third party users and even automated software applications.

Various embodiments of the invention previously described include a computer program product which is a storage medium (media) having instructions stored thereon/in and which can be used to program a general purpose or specialized computing processor(s)/device(s) to perform any of the features presented herein. The storage medium can include, but is not limited to, one or more of the following: any type of physical media including floppy disks, optical discs, DVDs, CD-ROMs, micro drives, magneto-optical disks, holographic storage, ROMs, RAMs, PRAMS, EPROMs, EEPROMs, DRAMs, VRAMs, flash memory devices, magnetic or optical cards, nanosystems (including molecular memory ICs); paper or paper-based media; and any type of media or device suitable for storing instructions and/or information.

Various embodiments include a computer program product that can be transmitted in whole or in parts and over one or more public and/or private networks wherein the transmission includes instructions which can be used by one or more processors to perform any of the features presented herein. In various embodiments, the transmission may include a plurality of separate transmissions.

Stored one or more of the computer readable medium (media), the present disclosure includes software for controlling both the hardware of general purpose/specialized computer(s) and/or processor(s), and for enabling the computer(s) and/or processor(s) to interact with a human user or other mechanism utilizing the results of the present invention. Such software may include, but is not limited to, device drivers, operating systems, execution environments and containers, as well as user interfaces and applications.

The foregoing description of the preferred embodiments of the present invention has been provided for purposes of illustration and description. It is not intended to be exhaustive or to limit the invention to the precise forms disclosed. Many modifications and variations can be apparent to the practitioner skilled in the art. Embodiments were chosen and described in order to best explain the principles of the invention and its practical application, thereby enabling others skilled in the relevant art to understand the invention. It is intended that the scope of the invention be defined by the following claims and their equivalents.

What is claimed is:

1. A method for enabling an interactive online process for electronic real estate transactions, said method comprising:
receiving input indicating a definition of a bidding file, said bidding file including multiple listing service (MLS) data regarding a real estate listing;
instantiating an interactive sales transaction from said bidding file, said interactive sales transaction based on the multiple listing service data;
receiving input indicating one or more fields;
generating an electronic bid and populating said electronic bid with said one or more fields;
initializing a time limit to acknowledge said electronic bid and gradually reducing said time limit until said time limit expires;
determining whether said electronic bid has been tagged as having been acknowledged upon expiration of said time limit; and
suspending future electronic bidding associated with said interactive sale transaction such that no new electronic bids are accepted for the transaction if said electronic bid has not been tagged as having been acknowledged by the expiration of said time limit.

2. The method of claim 1, further comprising:
receiving an acknowledgement of said electronic bid; and
resuming the future electronic bidding in said interactive sale transaction upon receiving the acknowledgement.

3. The method of claim 1, further comprising:
receiving input indicating acceptance of said electronic bid; and
tagging said electronic bid as having been accepted and completing the interactive sale transaction.

4. The method of claim 3 wherein said electronic bid that has been accepted is not the highest bid in a plurality of said electronic bids associated with said interactive sale transaction.

5. The method of claim 3, further comprising:
electronically inputting data retrieved from said interactive sale transaction into a contract form upon completing said interactive sale transaction.

6. The method of claim 1 wherein receiving input indicating definition of the bidding file further includes:
receiving input that indicates a total time duration of said interactive sale transaction.

7. The method of claim 6, further comprising:
discontinuing all electronic bidding for said interactive sale transaction once said total time duration has lapsed.

8. The method of claim 1, wherein said time limit is a parameter associated with said interactive sale transaction and customized by a user.

9. The method of claim 1 wherein said electronic bid further includes at least one of: a bid amount and one or more conditions associated with said interactive sale transaction, said one or more conditions being customizable upon submitting said electronic bid.

10. A system for providing an interactive online process for electronic real estate transactions, said system comprising:
a server connected to a network, said server having a bidding logic component deployed thereon, wherein said server receives a definition of a bidding file and instantiates an interactive sale transaction based on said bidding file; and
a client connected to the network, wherein said client generates one or more input fields for an electronic bid associated with said interactive sale transaction, populates said electronic bid with the input fields and submits said electronic bid to the bidding logic component such that said bidding logic component initiates a specified time limit count to acknowledge said electronic bid;
wherein said bidding logic suspends all future electronic bidding associated with the interactive sale transaction if said electronic bid is not acknowledged upon reaching said specified time limit.

11. A system for providing an interactive online sales process for an electronic real estate transaction, said system comprising:
a listing agent module that receives input containing multiple listing service data and generates a bidding file based on said data;
a bidding logic module that receives said bidding file and instantiates an electronic sale transaction based on said bidding file;
an electronic bid submitted to said bidding logic module by one or more clients, said electronic bid containing one or more fields for containing data associated with said electronic sale transaction, wherein said bidding logic module initiates a time limit to acknowledge said electronic bid upon receiving the electronic bid such that all future electronic bidding associated with said interactive sale transaction is suspended if said electronic bid is not acknowledged by the expiration of said time limit.

12. The system of claim 11 wherein said electronic bid further includes at least one of:
a set of standard conditions and a set of custom conditions, wherein said standard conditions are specified at initialization of said electronic sale transaction and wherein said custom conditions are defined upon submitting said electronic bid.

13. The system of claim 11 wherein said electronic bidding is resumed after said electronic bid is acknowledged by a user of said system.

14. The system of claim 11 wherein said electronic bid is accepted such that said electronic sale transaction is completed upon accepting said electronic bid.

15. The system of claim 14, further comprising:
a contract generator module activated upon accepting said electronic bid, wherein said contract generator module retrieves a set of data associated with said electronic sale transaction and automatically inserts said data into a real estate contract form.

16. The system of claim 14 wherein said electronic bid that is accepted is not necessarily the highest electronic bid from a group of bids associated with the electronic sale transaction.

17. The system of claim 11, further comprising:
a set of parameters associated with said electronic sale transaction, wherein said parameters are customized prior to instantiating said transaction.

18. The system of claim 17 wherein said parameters include at least one of:
a acknowledgment time parameter for specifying the time period for acknowledging each electronic bid;
a sale length parameter for specifying the time period of said electronic sale transaction such that the electronic sale transaction is terminated upon expiration of said time period;
a start time of said electronic sale transaction;
at least one standard condition associated with said electronic sale transaction; and
a minimum reserve price for accepting said electronic bid.

19. The system of claim 11 wherein said electronic bid can be tagged as being a favorite one of a plurality of electronic bids associated with said electronic sale transaction.

20. A computer readable medium carrying one or more sequences of instructions for providing an interactive sale process in electronic real estate transactions, which instructions, when executed by one or more processors, cause the one or more processors to carry out the steps of:
receiving input indicating a definition of a bidding file, said bidding file including multiple listing service (MLS) data regarding a real estate listing;
instantiating an interactive sales transaction from said bidding file, said interactive sales transaction based on said multiple listing service data;
receiving input indicating one or more fields;
generating an electronic bid and populating said electronic bid with said one or more fields;
initializing a time limit to acknowledge said electronic bid and gradually reducing said time limit until said time limit expires;
determining whether said electronic bid has been tagged as having been acknowledged upon expiration of said time limit; and
suspending future electronic bidding associated with said interactive sale transaction such that no new electronic bids are accepted for the transaction if said electronic bid has not been tagged as having been acknowledged by the expiration of said time limit.

21. A method for providing a negotiating process in electronic real estate transactions, said method comprising:
instantiating an electronic real estate transaction that contains multiple listing service (MLS) data associated with a real estate listing;
providing an electronic two-way communication mechanism between at least one buyer and a seller of said real estate transaction, said communication mechanism containing one or more of: a condition field, a response field and a comment field;
populating said condition field of the communication mechanism by the buyer and transmitting said communication mechanism to the seller;
receiving said communication mechanism by the seller and populating said response field of the communication mechanism by the seller; and
transmitting said communication mechanism to the buyer.

22. The method of claim 21 wherein both the buyer and the seller are allowed to populate the comment field of said communication mechanism.
